(19) United States
(12) Patent Application Publication
(10) Pub. No.: US 2020/0118038 A1
(43) Pub. Date: Apr. 16, 2020

(54) TECHNIQUES FOR IMPROVING DOWNSTREAM UTILITY IN MAKING FOLLOW RECOMMENDATIONS

(71) Applicant: Microsoft Technology Licensing, LLC, Redmond, WA (US)

(72) Inventors: Sami Ghoche, San Francisco, CA (US); Ankan Saha, San Francisco, CA (US); Andrew Hatch, Oakland, CA (US)

(21) Appl. No.: 16/156,114

(22) Filed: Oct. 10, 2018

(51) Int. Cl. G06N 99/00; G06N 5/02

(52) U.S. Cl. CPC G06N 99/005; G06N 5/022

(57) ABSTRACT

Described herein is a technique to generate and present follow recommendations. During a first stage or phase, training data are obtained by presenting follow recommendations to some randomly selected set of members, and then observing the collective members' responses. Using the training data, first and second predictive machine-learned scoring models are derived—the first scoring model for use in predicting when a member will opt to follow an entity being recommended, and the second scoring model for use in predicting if the member will engage with content presented via a newly formed follow edge. Then, using the scoring models, follow recommendations are derived, scored, and ultimately selected—based on their scores—for presentation to a member.

### TECHNICAL FIELD

The present application generally relates to computer technology for addressing technical challenges in making follow recommendations—that is, recommendations relating to entities (e.g., people, companies, topics, etc.) that are, or are otherwise associated with, sources of content in which an end-user might be interested. More specifically, the present application relates to a multi-step algorithm, using machine learning models, for making follow recommendations that are both likely to result in selection by the end-user to whom the recommendation is being presented, AND, likely to result in engagement with content that has been generated or published by, or otherwise published on behalf of or in association with, the entity being recommended.

### BACKGROUND

With many online systems, such as online social networking services, blogging sites, video- and photo-sharing sites, marketplaces, and other content publishing platforms, end-users consume content (e.g., read articles and stories, view pictures and videos, shop for items, etc.) that has been generated and/or shared by other end-users. In many instances, the content that is presented to any particular end-user is selected for presentation to the end-user as a result of the end-user having elected to “follow” an entity (e.g., person, company, channel, or topic) associated with the content. To “follow” an entity is akin to subscribing to a content source, such that, when content is published by or on behalf of the entity, the subscriber (e.g., follower) becomes eligible to view the published content. The published content may be presented to the follower via any of a number of content publishing applications, such as the feed, or news feed, of a social networking service.

As an example, with many social networking services, members elect to follow other members. As illustrated in FIG. 1A, and by way of example, a portion of a member profile 100 of a member (“Bill Greats”) of a social networking service is presented. As shown with reference 102, a button with the label, “FOLLOW”, is presented with the portion of the member profile. The viewing member—that is the member to whom the follow button 102 has been presented—can elect to follow the member whose profile is being presented (e.g., “Bill Greats”) by simply selecting the follow button 102. Subsequent to the viewing member selecting the follow button for the member, Bill Greats, the viewing member may be presented with content that is published or shared by the member, Bill Greats. As an example, if Bill Greats publishes a blog posting, the member following Bill Greats may be notified of the blog posting via a content item presented in a feed, such that the blog posting is accessible via the content item presented in the feed.

As illustrated in FIG. 1B, the result of an end-user following a set of entities can be presented as a directed graph 104. In this simplified example, “User X” is following another member, “User A”, a company, “Company B”, and a topic, “Topic C”. The directed edges of the graph that connect User X with the various other entities are referred to as follow edges 106 and provide a type of content access privilege. By following Company B, User X has the privilege to receive content that is published on behalf of Company B. Similarly, by following Topic C, User X has expressed an interest in receiving any content that might be classified as being relevant or related to Topic C.

This concept of following is prevalent in many other online systems beyond those related to social networking services. As an example, many video sharing sites provide for the ability to follow a content channel to receive and view content being published in connection with the channel. Similarly, online marketplaces provide the ability to follow sellers, product brands, and/or categories of products, and so forth, as a mechanism by which to provide a potential buyer with the ability to express his or her shopping preferences and/or interests.

The characteristics of the underlying graph formed when end-users follow other end-users (and, other entities) is important from the perspective of both the end-user and the operator of the online system. Because follow recommendations can have a significant impact on the formation of the underlying graph represented by the follow edges, it is extremely important to have an appropriately tuned follow recommendation engine. From the perspective of the end-user, it is important to be following a sufficient quantity of entities, so as to ensure that the end-user has access to a sufficient amount of content that is of interest to the end-user. Of course, quantity is only part of the equation. If an end-user is following entities that are not associated with quality content, or entities associated with content that is not of interest to the end-user, the end-user is not likely to engage with the content and may ultimately cease to use the online system. From the perspective of the entity operating the online system, if end-users are not engaging with content, not only will end-users cease to use the online system, but the lack of a well-connected graph of end-users may limit other targeted marketing opportunities for the operator of the online system. For instance, a follow edge is an important signal of an end-user's interests, which can be leveraged by many other services and products (e.g., content recommendations, job recommendations and advertising). Accordingly, online systems benefit significantly from having appropriate recommendation algorithms and systems in place to generate and present end-users with follow recommendations.

### BRIEF DESCRIPTION OF THE DRAWINGS

Embodiments of the present invention are illustrated by way of example and not limitation in the figures of the accompanying drawings, in which:

FIG. 1A is a user interface diagram showing an example of a portion of a member profile along with a follow button, for a social networking service, consistent with embodiments of the present invention;

FIG. 1B is a diagram showing an example of a directed graph that represents the results of an end-user electing to follow various entities represented in a social networking service, consistent with embodiments of the present invention;

FIG. 2 is a block diagram showing the functional components of a social networking service, including a data processing module referred to herein as a follow recommendation engine, for use in generating and presenting follow recommendations, consistent with some embodiments of the present invention.

FIG. 3 is a block diagram showing the functional components of a follow recommendation engine, for generating follow recommendations, consistent with some embodiments of the present invention;

FIG. 4 is a flow diagram illustrating a method of obtaining training data and learning, via machine-learning techniques, a predictive scoring model for scoring follow recommendations for members of a social networking service, consistent with embodiments of the present invention;

FIG. 5 is a flow diagram illustrating a method, performed offline, of scoring follow recommendations on a per member basis, using machine-learned scoring models, consistent with embodiments of the invention;

FIG. 6 is a flow diagram illustrating a method, performed online or in real-time, for ranking and presenting follow recommendations, responsive to a request and consistent with embodiments of the present invention;

FIG. 7 is a user interface diagram showing an example of a user interface presenting follow recommendations to a viewing member, where each follow recommendation is associated with another member, consistent with embodiments of the invention;

FIG. 8 is a user interface diagram showing an example of a feed via which content is presented, and in particular, content that may be associated with a follow edge between a viewing member and an entity associated with the content; and

FIG. 9 is a system diagram illustrating an example of a computing device with which, embodiments of the present invention might be implemented.

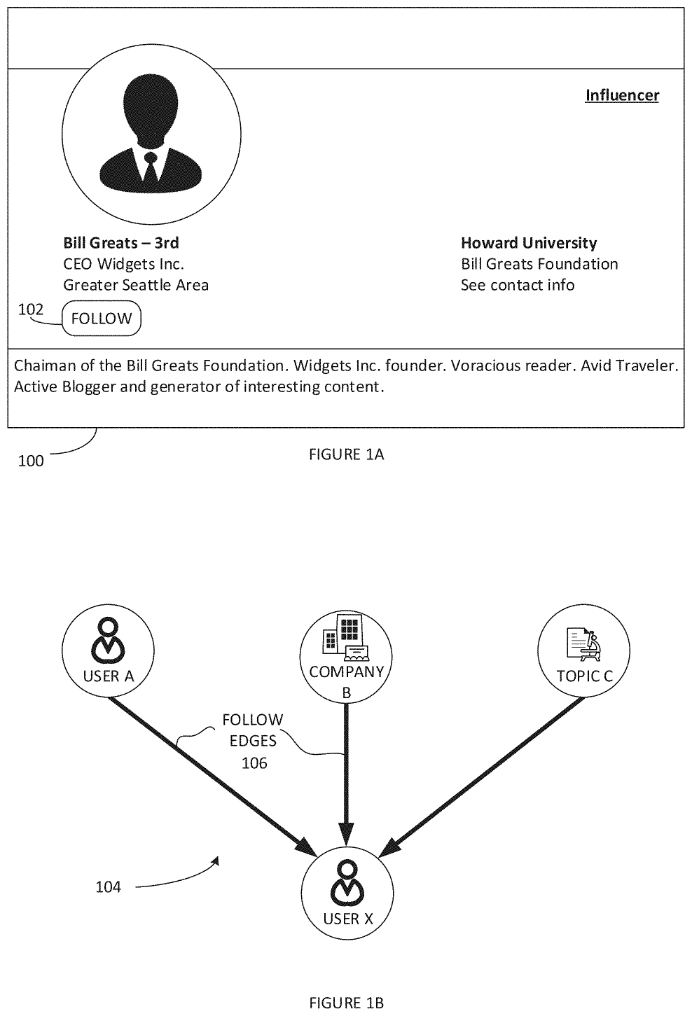

### DETAILED DESCRIPTION

Described herein are methods, systems and computer program products to facilitate the generation and presentation of follow recommendations to a recommendation-recipient, such that the follow recommendations are ranked based on a combination of a first metric representing a likelihood or probability that the recommendation-recipient will elect to follow a particular entity (e.g., member, company, topic, etc.) when presented with a recommendation to follow the entity, and a second metric representing a level of predicted engagement that the recommendation-recipient will exhibit in connection with content generated or published by, on behalf of, or in connection with, the entity being recommended, subsequent to the recommendation-recipient electing to follow the entity being recommended. In the following description, for purposes of explanation, numerous specific details are set forth in order to provide a thorough understanding of the various aspects of different embodiments of the present invention. It will be evident, however, to one skilled in the art, that the present invention may be practiced without all of these specific details.

A variety of techniques exist for generating recommendations in the context of online systems. In a typical online system, follow recommendations are generally derived with one goal in mind—generating and presenting follow recommendations for entities (e.g., members, companies, channels, topics, etc.) that the end-user will elect to follow, thereby resulting in a new follow edge. As an example, many social networking services use what may be referred to as neighborhood-based methods for generating follow recommendations. Using this method, a member (e.g., User A) who chooses to follow another member (e.g., User B) may be presented with a recommendation to follow a third member (e.g., User C), if the other member (e.g., User B) is also following the third member (e.g., User C.) Another common technique involves what may be referred to as similarity-based methods. Under this type of approach, some measure of similarity between entity attributes is used to identify those entities that are most similar to the recommendation-recipient, or, to identify those entities most similar to another entity being followed by the recommendation-recipient. Those entities that are determined to be most similar are then presented to the recommendation-recipient as follow recommendations.

The problem with these approaches is that the primary objective—establishing new follow edges—is not necessarily well aligned with many of the other goals and objectives deemed important by the recommendation-recipient and/or the operator of the online system or service. As a result, presenting follow recommendations using the above-mentioned techniques may result in the formation of new follow edges, but the follow edges may not be optimal for achieving other goals and objectives. Specifically, the follow edges formed via follow recommendations generated using the techniques described above may not increase or drive member engagement in any meaningful way. Consider a simple scenario where a first member (e.g., User A) is following a second member (e.g., User B), who is following a third member (e.g., User C), where all three members share many attributes in common. For instance, perhaps all three members are colleagues working for the same company, within the same industry, with the same or similar job titles, and the same or similar educational backgrounds. If the first member (e.g., User A) is already following the second member (e.g., User B), and the second member (e.g., User B) is already following the third member (e.g., User C), a follow recommendation presented to the first member (e.g. User A) to follow the third member (e.g., User C) may not result in any meaningful new content engagement for the first member (e.g., User A). This is because all three members share common interests and are likely to be interested in the same content. Because the first member (e.g., User A) is receiving content already from the second member (e.g., User B), additional content received from the third member (e.g., User C) may be redundant at best.

Accordingly, consistent with embodiments of the present invention, follow recommendations are generated and then scored, and ranked in accordance with a measure of their respective downstream utility. The concept of downstream utility is best understood as a utility score that is based on a combination of a first score or probability, representing the likelihood that a member will choose to follow a recommended entity if/when presented as a follow recommendation, thereby resulting in a new follow edge, and a second score or probability, representing the likelihood that the member will engage with content published in association with, or on behalf of, the recommended entity subsequent to the formation of a new follow edge. As such, the downstream utility score, or simply, utility score, is derived to encapsulate not one, but two separate objectives. The first objective is to present follow recommendations that will result in new follow edges, whereas the second objective is to present follow recommendations that will increase content engagement.

Consistent with some embodiments, to derive utility scores for follow recommendations, two separate machine-learned scoring models are first generated. Each scoring model is then used to score follow recommendation candidates based on separate objectives and feature sets. A first machine-learned scoring model is derived for use in predicting the likelihood that an entity (e.g., a member, company, or topic), if presented to a recommendation-recipient, will be followed by the recommendation-recipient. A second machine-learned scoring model is derived for use in predicting a level of engagement the recommendation-recipient will exhibit in connection with content that is presented in association with, or published on behalf of, the entity that is being recommended to the recommendation-recipient. The utility score assigned to each follow recommendation is calculated as a combination of the first and second scores. For instance, with some embodiments, the final utility score assigned to each follow recommendation may simply be the product of the first and second scores for the follow recommendation.

To derive the scoring models, training data are first obtained. Consistent with some embodiments, to obtain the training data, a set of follow recommendations are first presented to some randomly selected set of members. Then, the members' responses to the follow recommendations are monitored. For example, when presented with a follow recommendation, does a member choose to follow the entity being recommended—a positive response—or, does the member take no action—a negative response. Using the collective member response information obtained during the training phase, a first machine-learned scoring model is derived, where the first scoring model is for use in predicting the likelihood that a member, when presented with a particular follow recommendation, will choose to follow the recommended entity.

Similarly, for those follow recommendations that result in a new follow edge (a positive response), member engagement information is obtained for some period of time subsequent to the formation of the new follow edge. For example, the member engagement information may be information pertaining to the number of times a member positively interacts with content that is presented to the member in connection with a newly formed follow edge. In this context, an interaction may be any one of several social gestures, such as: viewing a content item, commenting on a content item, sharing or re-sharing a content item, up-voting or “liking” a content item, and so forth. Using the collective member engagement information for new follow edges, a second machine-learned scoring model is derived for use in predicting the likelihood that a member will engage with content associated with a new follow edge in some time period immediately subsequent to the formation of the new follow edge.

Once the first and second machine-learned scoring models are generated, on some periodic basis (e.g., monthly, weekly, nightly, etc.) an offline or batch computation process occurs to generate for each member a set of follow recommendations and corresponding follow recommendation utility scores. For example, for a given member and follow recommendation candidate, a first set of machine learning features are obtained for the member and the entity subject to the recommendation (e.g., the follow recommendation candidate), which may be a member, a company, a topic or channel, or some other entity associated with a content source. The first set of features may be obtained from the respective profiles of the member and the follow recommendation candidate, and as such, may include various attributes describing the member and/or follow recommendation candidate. Additional features may be obtained from activity and interaction information relating to content with which the member, or follow recommendation candidate, has interacted. The first set of features are then provided as input to the first machine-learned scoring model to calculate a first score for the member and follow recommendation candidate pair. Similarly, a second set of features are obtained and provided as input to the second machine-learned scoring model to calculate a score representing the likelihood that the member will engage with content published by, or on behalf of, the entity associated with the follow recommendation candidate. Finally, the first and second scores are combined (e.g., multiplied together) to arrive at a utility score for the follow recommendation candidate. The follow recommendation candidate and corresponding utility score are then written to a database for subsequent recall. This process is repeated for some number of follow recommendation candidates, and for some set of members, such that, for each member in some large set of members, the member will have some number of follow recommendation candidates and corresponding utility scores stored and available for recall.

As will be described in greater detail below, upon a request to present follow recommendations to a member, the follow recommendations and corresponding utility scores for the member are retrieved from storage. Some additional processing (e.g., re-ranking) is done in real time—that is, responsive to a request—before a final selection of follow recommendations are generated and provided to the requesting application or service, for presentation to the member. Other aspects of the present invention will be readily ascertainable from the description of the figures that follows.

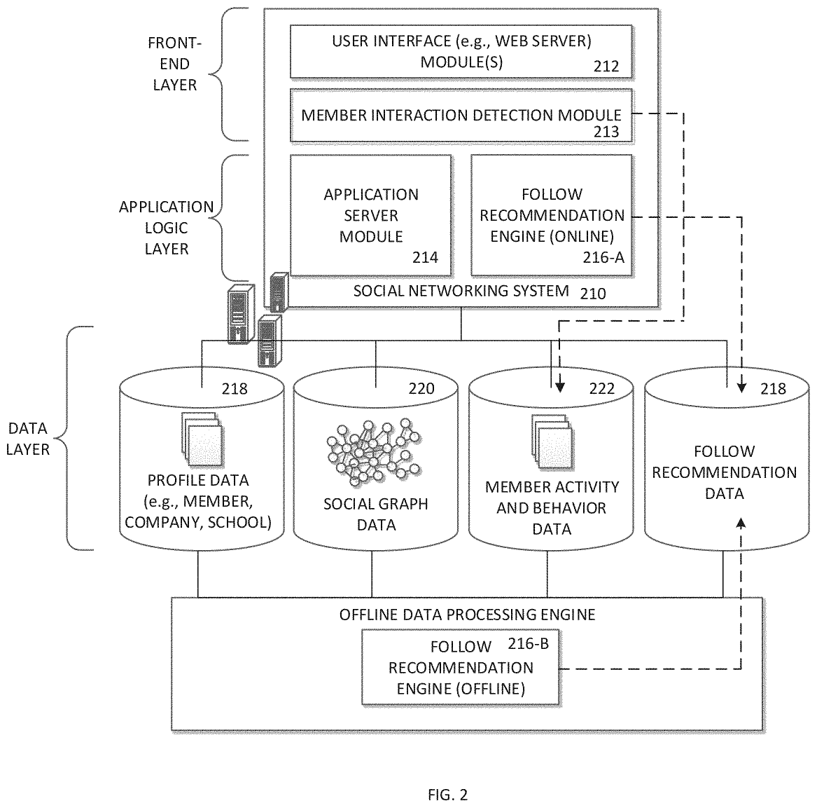

FIG. 2 is a block diagram showing the functional components of a social networking service or system 210, including a data processing module referred to herein as a follow recommendation engine, which, in this example, is comprised of online 216-A and offline 216-B components, for use in generating and presenting follow recommendations, consistent with some embodiments of the present invention. As shown in FIG. 2, the social networking system 210 is implemented with a three-layered architecture, generally consisting of a front-end layer, an application logic layer and a data layer. Of course, in other embodiments, different architectures may be used.

The front-end layer may comprise a user interface module (e.g., a web server) 212, which receives requests from various client computing devices and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications, services, and content presented. As shown in FIG. 2, upon detecting a particular interaction, the member interaction detection module 213 logs the interaction, including the type of interaction and any metadata relating to the interaction, in a member activity and behavior database 222.

The application logic layer may include one or more various application server modules 214, which, in conjunction with the user interface module(s) 212, generate various user interfaces (e.g., web pages) with data retrieved from various data sources in the data layer. Consistent with some embodiments, individual application server modules 214 are used to implement the functionality associated with various applications and/or services provided by the social networking system 210.

As shown in FIG. 2, the data layer may include several databases, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of following another member is a unilateral operation and, at least in some embodiments, does not require acknowledgement or approval by the member that is being followed. When one member follows another, the member who is following may receive content published by the member being followed, or the member may receive updates or notifications relating to various activities undertaken by the member being followed. Similarly, when a member follows an organization, the member becomes eligible to receive content published on behalf of the organization. For example, content published on behalf of an organization that a member is following will appear in the member's personalized feed, sometimesreferred to as a news feed, activity stream or content stream. In any case, the various associations and relationships that the members establish with other members, or with other entities and objects, are stored and maintained within a social graph in a social graph database 220, as shown in FIG. 2.

As members interact with the various applications, services, and content made available via the social networking system 210, the members' interactions and behavior (e.g., content viewed, links or buttons selected, messages responded to, etc.) may be tracked, and information concerning the members' activities, interactions and behavior may be logged or stored, for example, as indicated in FIG. 2, by the member activity and behavior database 222. This logged activity information may then be used by the follow recommendation engine 216 to generate follow recommendations for a member.

As shown in FIG. 2, the offline data processing engine comprises a framework for distributed storage and processing of extremely large data sets. In one example, the offline data processing engine may be implemented using Hadoop®, the Hadoop Distributed File System (HDFS™) and the MapReduce programming model. Of course, any of a number of other alternative frameworks might also be use. The offline portion of the follow recommendation engine 216-B obtains data from the data layer, and then processes the data to generate a first machine-learned scoring model, for use in predicting the likelihood that a member will, when presented with a particular follow recommendation, elect to follow the entity being recommended thereby resulting in a new follow edge. Additionally, the offline portion of the follow recommendation engine 216-B generates a second machine-learned scoring model for use in predicting the likelihood that a member will, having elected to follow a recommended entity, engage with content published by, or on behalf of, the recommended entity, in some time period immediately subsequent to the formation of the new follow edge.

With the first and second machine learned scoring models having been generated, the offline portion of the follow recommendation engine 216-B will periodically perform a batch computation to generate for each member in a set of members, a set of follow recommendations with corresponding follow recommendation utility scores. For example, given a particular member, using some broad heuristics, a set of follow recommendation candidates is first determined for the particular member. For each follow recommendation candidate in the set, a follow recommendation utility score is calculated by providing to the first and second machine-learned scoring models first and second features sets, and then combining the scores that result from the respective scoring operations. Accordingly, for each member in the set of members, the result is some set of scored follow recommendation candidates stored as follow recommendation data, for example, by the database with reference number 18.

Upon receiving a request for follow recommendations for a particular member, the online portion of the follow recommendation engine 216-A will retrieve the follow recommendation candidates that have been stored for the particular member, rank or order the follow recommendation candidates in accordance with their respective follow recommendation utility scores, and then provide some subset of the ranked and ordered follow recommendations to the requesting application or service, for eventual presentation to the particular member.

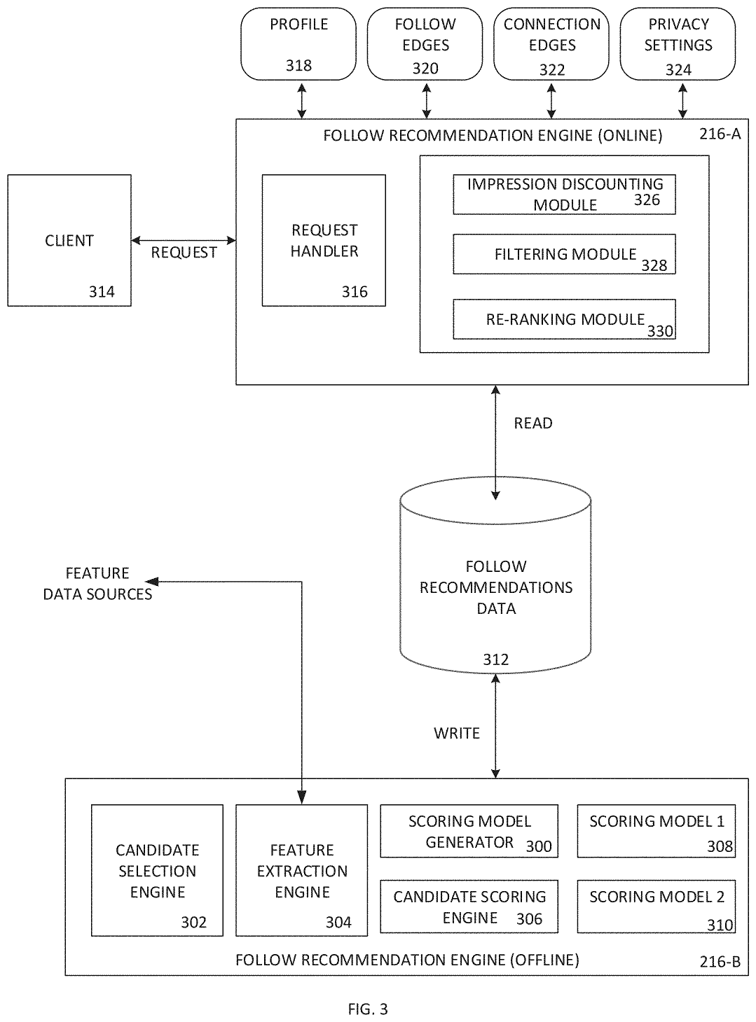

FIG. 3 is a block diagram showing the functional components of a follow recommendation engine, for generating follow recommendations, consistent with some embodiments of the present invention. In general, the inventive process for generating follow recommendations can be thought of as occurring in three phases. During the first phase, first and second machine-learned scoring models are generated with training data obtained by presenting follow recommendations to some randomly selected set of members, and then observing the responses. During the second phase, using the two machine-learned scoring models generated in the first phase, for each member in some set of members, a set of follow recommendations and corresponding follow recommendation utility scores are generated and stored. Finally, during the third phase, upon receiving a request for follow recommendations to be presented to a particular member, the previously stored follow recommendations are retrieved, ranked, and eventually presented to the particular member. More precisely, at least with some embodiments, some top ranked number of follow recommendations are presented to a member.

As shown in FIG. 3, the offline portion of the follow recommendation engine 216-B includes a scoring model generator 300, a candidate selection engine 302 and a feature extraction engine 304. During the first phase—the training phase—the candidate selection engine 302 will randomly select a set of members to whom a set of follow recommendations are to be presented. As opportunities arise to present the follow recommendations to the members in the randomly selected set of members, the responses those members have to the follow recommendations are monitored and stored. For example, if a member chooses to follow a recommended entity—a positive response—this member response information is stored for use in training the first scoring model. If a member views a follow recommendation but takes no action—a negative response—this member response information is also stored for use in training the first scoring model.

Similarly, for some period of time subsequent to a member creating a new follow edge by electing to follow a recommended entity, that member's interactions with content presented in connection with the new follow edge will be monitored. If a member exhibits any of a variety of positive interactions with content associated with a new follow edge, these positive interactions are monitored and stored for subsequent use in generating the second scoring model. By way of example, a positive interaction with content might be any of the following: selecting a content item to view, commenting on a content item, sharing a content item, and/or up-voting or “liking” a content item. Of course, negative interactions generally consist of viewing a content item, but not taking any action. This member engagement information is stored for subsequent use in training the second machine-learned scoring model for use in predicting when a member will engage with content presented in connection with a newly formed follow edge.

After a sufficient number of follow recommendations have been presented to the randomly selected set of members, and a sufficient amount of response information and engagement information have been observed, the scoring model generator 300 uses the member response information and the engagement information to train the first and second scoring models (308 and 310), respectively. With some embodiments, logistic regression modeling is performed to generate predictive models from the observed data (e.g., the member response information and the engagement information). Accordingly, the result of training the first scoring model is an equation that combines a specific set of input values (e.g., features), with learned scaling factors (e.g., co-efficients), the solution to which is the predicted output—that is, the score that represents the likelihood that a follow recommendation will be selected by the member, resulting in a new follow edge. The second scoring model is derived in a similar manner, but with different input values (e.g., features). Of course, other techniques are possible and within the realm of the inventive subject matter.

During the second phase—the candidate scoring phase—the candidate selection engine 302 will use broad heuristics to select a set of follow recommendation candidates for each member in some set of members. For a given member and follow recommendation candidate pair, the feature extraction engine 304 will request and obtain relevant features for use in scoring the follow recommendation candidate using the predictive, machine-learned scoring models that were generated during the first phase. The features may be requested from any number and variety of data sources but will generally be data attributes relating to the profiles of the member and the entity being recommended, and relevant interaction or activity data. A first set of features is provided as input to the candidate scoring engine 306, which uses the first scoring model 308 to derive a first score, representing a likelihood that the member will choose to follow the follow recommendation candidate when presented with the follow recommendation. Similarly, using a second set of features obtained by the feature extraction engine 304, the candidate scoring engine 306 feeds the second set of features as input to the second scoring model, for generating a score representative of the likelihood that the member will engage with content presented by, or on behalf of, the recommended entity, during some period of time immediately subsequent to the formation of a new follow edge. Finally, the first score and second score are combined in some manner—for example, by taking the product of the two scores in some instances—to generate a follow recommendation utility score for the follow recommendation. This process of generating and storing follow recommendations (e.g., candidates and corresponding scores) is repeated for each member in some set of members until each member has a sufficient number of scored follow recommendation candidates stored (e.g., as follow recommendations data 312).

During the third phase—the online phase—a member, using a client application 314 executing on a client device, will navigate to an interface (e.g., web page, or similar), causing a request to be communicated for a set of follow recommendations for the viewing member. Upon receiving the request, a request handler 316 will initiate a series of parallel requests for information. Specifically, using some information (e.g., member ID) received with the request and identifying the particular member for whom follow recommendations are being requested, a set of follow recommendations for the member are obtained (e.g., from the follow recommendation data 312) and the request handler 316 will request profile information 318, follow edges 320 and connection edges 322 for the particular member, and privacy settings 324 for those entities for which a follow recommendation is received. The profile information, follow edges, connection edges and privacy setting information are provided as input to the filtering module 326, which uses the information to filter the obtained follow recommendations, e.g., thereby excluding any follow recommendations associated with entities that the particular member is already following, or with which the member has recently established a connection, or, for which the privacy settings are inconsistent with presentation of a follow recommendation. This is done to avoid making a follow recommendation for an entity that the member is already following, or for an entity to which the member is already connected, or for an entity that has expressed not to be recommended.

In addition, consistent with some embodiments, the profile information may include information about follow recommendations that were previously presented to the member. At least with some embodiments, there is a preference to avoid showing a member the same follow recommendation(s) over and over again, particularly when the member has viewed the follow recommendation and not acted—e.g., followed the entity being recommended. Accordingly, the impression discounting module 328 will apply a discount to the utility score of any follow recommendation that the member has previously viewed. With some embodiments, the discount factor may vary with time, such that those follow recommendations more recently viewed are more heavily discounted, and so forth. By discounting the utility score with an impression discounting factor, those follow recommendations previously viewed by the member are assigned lower overall utility scores, and are thus less likely to be presented to the member, or if presented, will be lower in order (e.g., less prominently positioned on the interface).

Finally, the re-ranking module 330 will rank the follow recommendations based on their adjusted utility scores. Some subset—e.g., the top N ranked—follow recommendations are then returned to the requesting client 314 for presentation to the member.

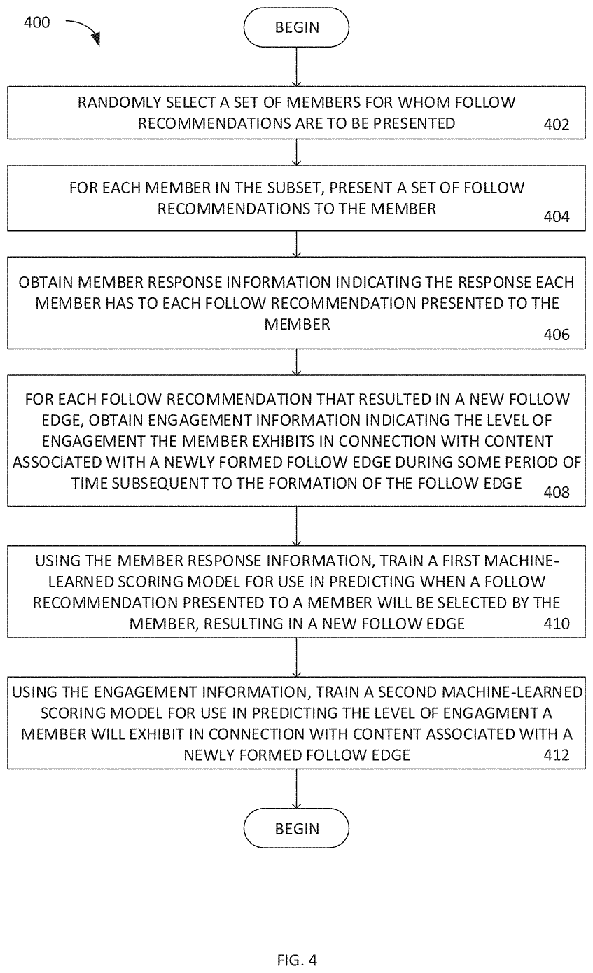

FIG. 4 is a flow diagram illustrating a method of obtaining training data and learning, via machine-learning techniques, a scoring model for scoring follow recommendations for members of a social networking service, consistent with embodiments of the present invention. As shown if FIG. 4, the method 400 begins when, at operation 402, a set of members are randomly selected to have follow recommendations presented to the members, in part for the purpose of obtaining training data. At method operation 404, for a member in the randomly selected set of members, a set of follow recommendations is presented. The presentation of the set of follow recommendations may occur in a single interface dedicated to the presentation of follow recommendations. Alternatively, individual follow recommendations may be presented to the member in a serial manner via some other interface or application, such as in a feed or news feed. In any case, each member in the randomly selected set of members is presented with multiple follow recommendations over some period of time. During that time, as shown with reference number 406, member response data is obtained, where the member response information indicates the response that each member has to the presentation of a particular follow recommendation. Selection of a follow recommendation is recorded as a positive response, whereas, viewing but not selecting a follow recommendation is recorded as a negative response.

Next, at method operation 408, for each follow recommendation that is associated with a positive response and the formation of a new follow edge, during some time period subsequent to the formation of the new follow edge, a member's engagement with content associated with the new follow edge is observed. For instance, if the member interacts with content (e.g., likes the content, shares the content, etc.) that has been posted by another newly followed member, the interaction is recorded as a positive response or interaction. Similarly, if a member views, but does not take action on some content associated with a new follow edge, the lack of any interaction or engagement with respect to the content is recorded as a negative response.

At method operation 412, using the member engagement information that was obtained (e.g., during method operation 408), a second machine-learned scoring model is trained for use in predicting the level of engagement a member will exhibit with content associated with a new follow edge, during some time period immediately subsequent to the formation of the new follow edge. The first and second scoring models are both stored for subsequent use in scoring follow recommendations. With some embodiments, the scoring models are periodically updated, using additional training data that may be obtained over some period of time.

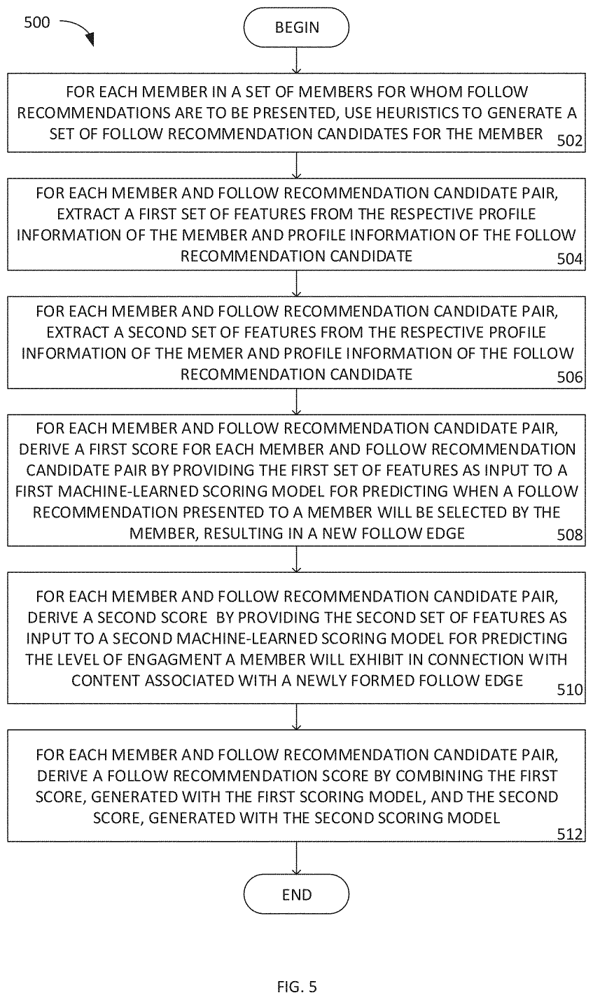

FIG. 5 is a flow diagram illustrating a method, performed offline, of scoring follow recommendations on a per member basis, using machine-learned scoring models, consistent with embodiments of the invention. Once the first and second scoring models are generated, follow recommendations for each member in some population of members are scored and stored for subsequent recall and presentation to the respective members. For example, as indicated with reference number 502, for each member in some population of members for whom follow recommendations are to be generated and presented, some broad heuristics are used to identify a set of follow recommendation candidates for each member.

At method operation 504, for a particular member and follow recommendation candidate pair, a first set of features are obtained from the respective profiles of the member and the entity to which the follow recommendation pertains. Next, at method operation 506, a second set of features, for use with the second scoring model, are obtained for the member and then follow recommendation candidate. With some embodiments, the features may be obtained from any one of several different data sources, and may include, in addition to traditional profile attributes and characteristics, information relating to the activities and interactions that the member, and in some instances, a member being recommended, have taken. Similarly, the features may include information about other members who have interacted with the entity being recommended, and/or the member to whom the follow recommendation is to be presented. In any case, as part of the feature extraction process, some data manipulation may occur to prepare and format the input data for use with the scoring operation. For example, with some embodiments, the dimensionality of the data may be reduced, and one or more feature vectors may be generated to make the scoring operation more resource and computationally efficient.

At method operation 508, for each member and follow recommendation candidate pair, the first feature set is used as input to the first scoring model to calculate a first score that represents the likelihood that the member, if and when presented with a follow recommendation corresponding to the entity of the follow recommendation candidate, will elect to follow the entity being recommended. Then, at method operation 510, the second set of features is used as input to the second scoring model to calculate a second score that represents a measure of how likely the member is to engage with content that is published by, on behalf of, or otherwise in association with, the entity being recommended. Finally, at method operation 512, the first and second scores are combined to derive a final follow recommendation utility score for the follow recommendation candidate. The follow recommendation candidate and corresponding follow recommendation utility score are written to a database for subsequent recall. This process is reported for some suitable number of follow recommendation candidates, for each member in the population of members for whom follow recommendations are to be presented.

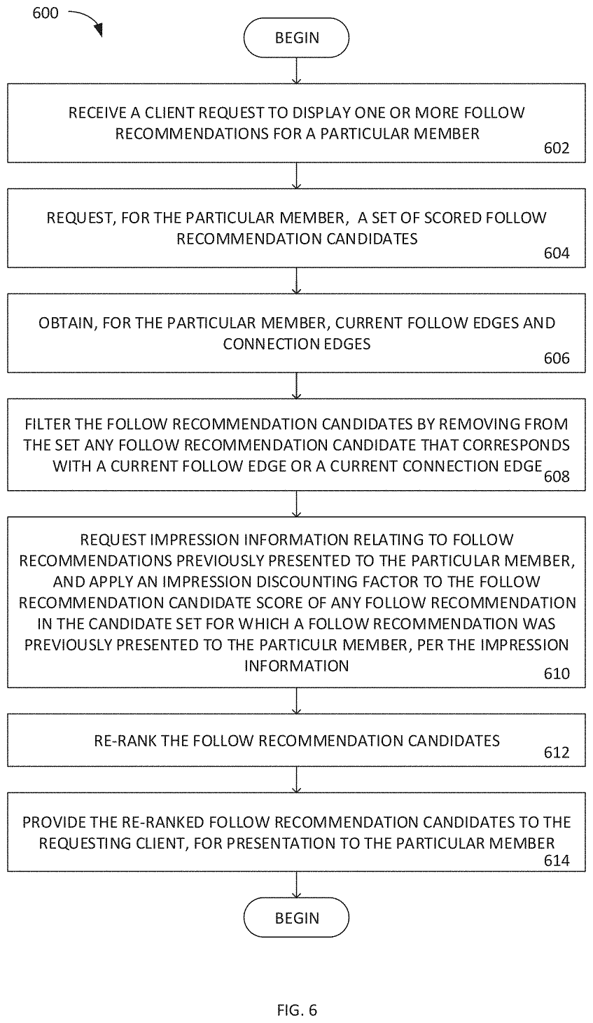

FIG. 6 is a flow diagram illustrating a method, performed online or in real-time, for ranking and presenting follow recommendations, responsive to a request and consistent with embodiments of the present invention. At method operation 602, a request is received for follow recommendations to be presented to a particular member. The request may identify the member, e.g., by including in the request a member identifier (ID). At method operation 604, a request or query is communicated to a data store that is storing predetermined follow recommendations and corresponding utility scores, for the particular member. At method operation 606, the current follow edges and connection edges for the particular member are obtained. Accordingly, at method operation 608, those follow recommendations associated with an entity that, according to the current follow edges and connection edges, the member is already following or to which the member is already connected, are filtered out so that the entities are not presented as follow recommendations.

Next, at operation 610, impression information relating to the follow recommendations that the member has previously viewed is obtained, and used in discounting the utility score of any follow recommendation that has previously been viewed by the member. Finally, the follow recommendations are re-ranked, consistent with their adjusted utility scores, and provided to the requesting application or service, for ultimate presentation to the member.

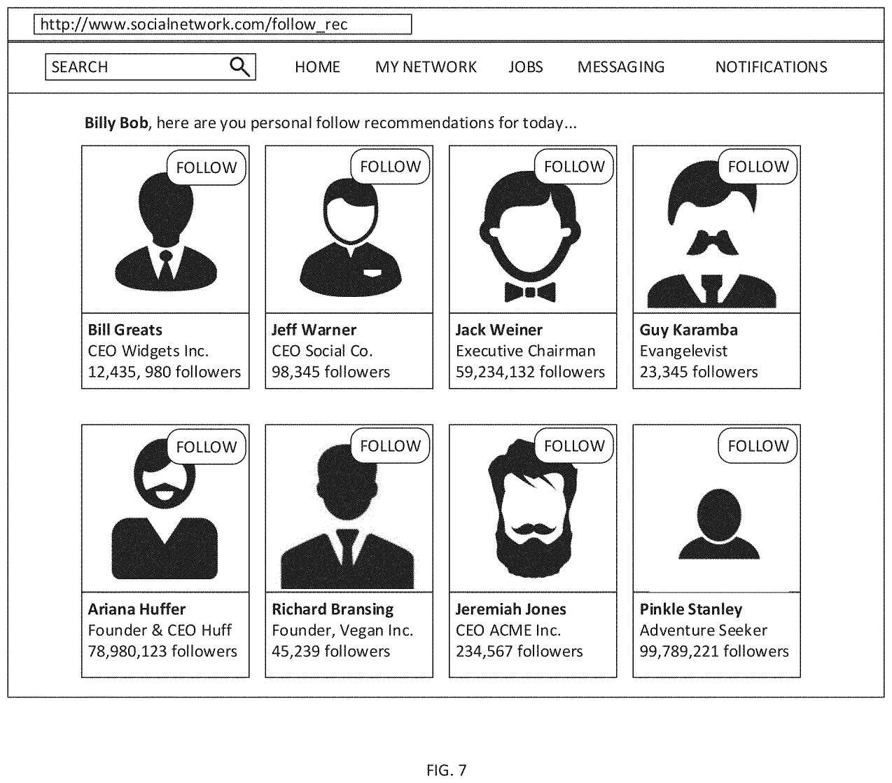

FIG. 7 is a user interface diagram showing an example of a user interface presenting follow recommendations to a viewing member, where each follow recommendation is associated with another member, consistent with embodiments of the invention. Consistent with FIG. 7, a set of ranked follow recommendations are presented. In this example, all of the follow recommendations are for other members. However, in other scenarios, the follow recommendations might be for other entities, and may be for a mix of entity types. For example, at least in the context of some applications or services (e.g., social networking services), the entity types may include in addition to other members, companies, and/or topics or channels. Of course, in other context, other entity types may be used.

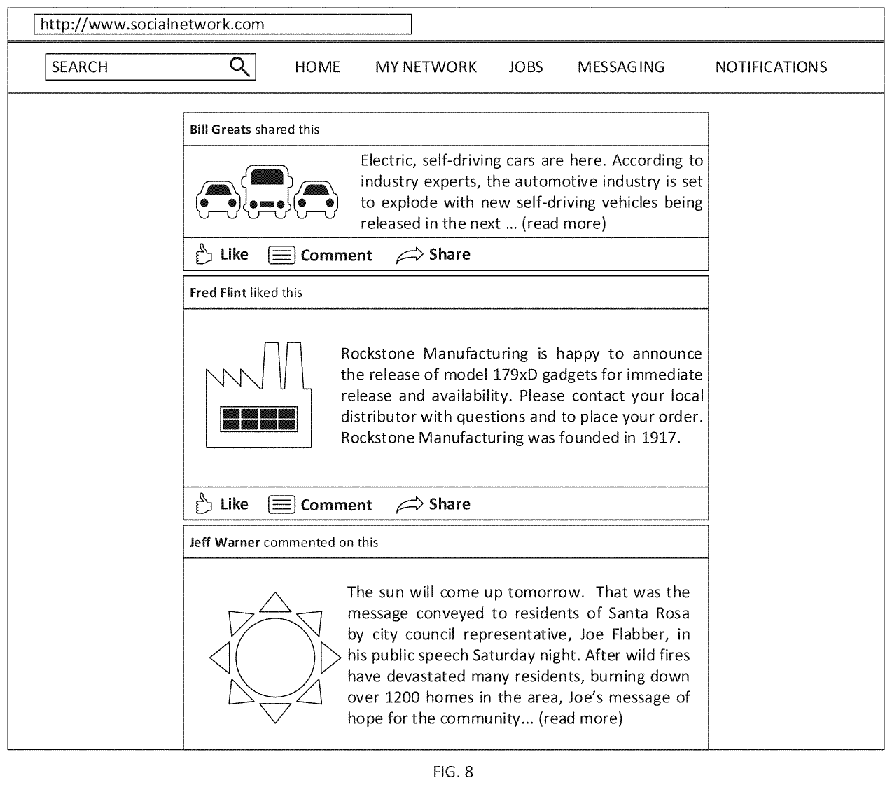

FIG. 8 is a user interface diagram showing an example of a feed via which content is presented, and in particular, content that may be associated with a follow edge between a viewing member and an entity associated with the content. In the example user interface of FIG. 8, the viewing member is presented with a feed that has three separate content items. These content items may be selected for presentation to the viewing member as a result of the viewing member opting to follow the member who has published the content. In the case of following a company, the viewing member may be presented with content published on behalf of the company. And, in the case of following a topic or channel, the viewing member may be presented with content that is analyzed and determined to be associated with the topic, or, published in connection with the topic or channel.

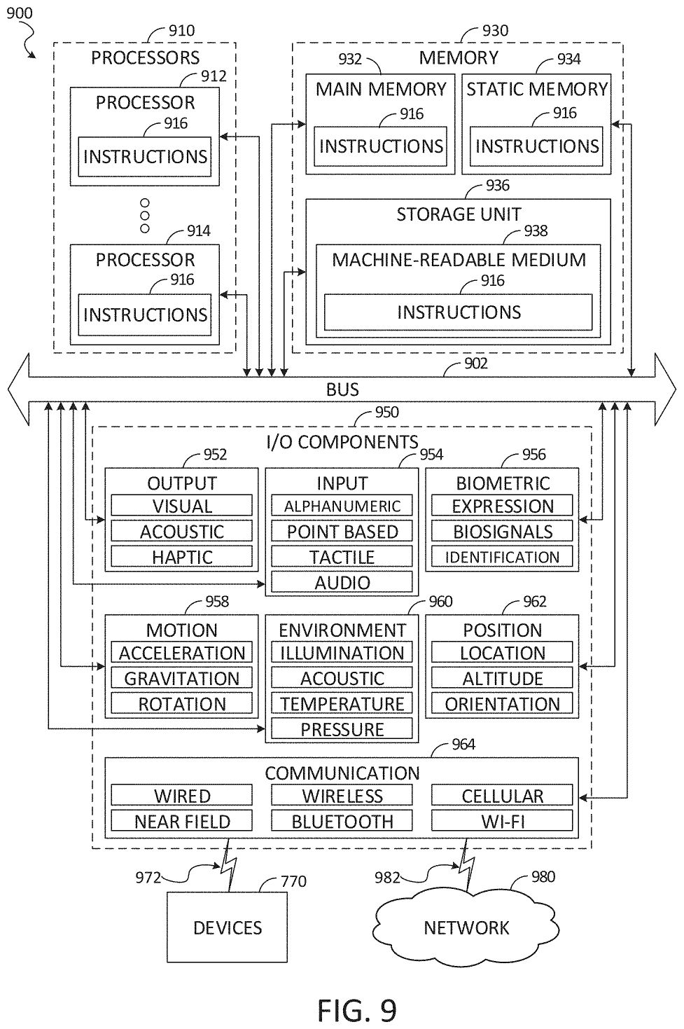

FIG. 9 illustrates a diagrammatic representation of a machine 900 in the form of a computer system within which a set of instructions may be executed for causing the machine to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods 400, 500, or 600. Additionally, or alternatively, the instructions 916 may implement the systems described in connection with any of FIG. 2 or 3, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

1. A system for generating follow recommendations for an online computer system, the system comprising:
a computer readable medium having instructions stored thereon, which, when executed by a processor, cause the system to:
present follow recommendations to some subset of randomly selected first set of members of an online service;
obtain member response information indicating a response each member in the first set of members has to each follow recommendation presented to the member;
for each follow recommendation that resulted in formation of a new follow edge, obtain engagement information indicating a level and type of engagement each member exhibited in connection with content items associated with a newly formed follow edge during some period of time subsequent to the formation of the follow edge;
using the member response information, train a first machine-learned scoring model for use in predicting when a follow recommendation presented to a member will be selected by the member, resulting in formation of a new follow edge;
using the engagement information, train a second machine-learned scoring model for use in predicting a level of engagement a member will exhibit in connection with content associated with a newly formed follow edge; and
store both the first and second machine-learned scoring models for subsequent scoring of follow recommendations for members not in the randomly selected first set of members, wherein each follow recommendation generated for a member will be based on a combination of a first score, generated with the first machine-learned scoring model, and a second score, generated with the second machine-learned model.

2. The system of claim 1 further comprising:
additional instructions stored on a computer readable medium, which, when executed by a processor, cause the system to:
for some set of members not in the subset of randomly selected first set of members, using broad heuristics, generate for each member a set of follow recommendation candidates;
for each pairing of a member and a follow recommendation candidate, extract a first set of features and a second set of features from the respective profiles of the member and the follow recommendation candidate, and a third set of features for the pairing of the member and the follow recommendation candidate;
for each pairing of a member and a follow recommendation candidate, derive a first score by providing the first set of features as input to the first machine-learned scoring model for predicting when a follow recommendation presented to a member will be selected by the member, resulting in formation of a new follow edge;
for each pairing of a member and a follow recommendation candidate, derive a second score by providing the second set of features as input to the second machine-learned scoring model for predicting a level of engagement a member will exhibit in connection with content associated with a newly formed follow edge;
for each pairing of a member and a follow recommendation candidate, derive a follow recommendation utility score, wherein the follow recommendation utility score is a combination of the first score and the second score;
storing in a data store the follow recommendation utility score for each pairing of a member and a follow recommendation candidate.

3. The system of claim 2 further comprising:
additional instructions stored on a computer readable medium, which, when executed by a processor, cause the system to:
receive a request, associated with a particular member, for follow recommendations to be presented to the particular member;
retrieve from the data store some subset of follow recommendation candidates and corresponding follow recommendation utility scores for the particular member;
rank the follow recommendation candidates in accordance with their respective follow recommendation utility scores; and
cause some number of the follow recommendation candidates to be presented to the particular member as follow recommendations, the follow recommendations ordered in accordance with their respective rank.

4. The system of claim 3 further comprising:
additional instructions stored on a computer readable medium, which, when executed by a processor, cause the system to:
obtain impression information identifying follow recommendations that were previously presented to the particular member in some period of time prior to when the request was received; and
discounting the follow recommendation utility score for follow recommendation candidates associated with follow recommendations that were presented to the particular member in the period of time prior to when the request was received.

5. The system of claim 4 further comprising:
additional instructions stored on a computer readable medium, which, when executed by a processor, cause the system to:
subsequent to the request being received, obtain information identifying entities the member has elected to follow and entities with whom the member has connected since the follow recommendation utility scores were last derived for the particular member; and
prior to ranking, excluding from the subset of follow recommendation candidates and follow recommendation candidate corresponding with an entity the member has elected to follow and/or with whom the member has connected since the follow recommendation utility scores were last derived for the particular member.

6. The system of claim 1, wherein the first machine-learned scoring model is based on a logistic regression model having a set of inputs and a single output, and the second machine-learned scoring model is based on log-linear regression having a set of inputs and a single output.

7. The system of claim 1, wherein the member response information includes information indicating a positive response when a member viewed a follow recommendation and then opted to follow the entity being recommended, and information indicating a negative response when a member viewed a follow recommendation and then took no action with respect to the follow recommendation

8. The system of claim, wherein the output of the second machine-learned scoring model, based on log-linear regression, is an estimate of the log of the expected number of interactions the member will have with a follow recommendation over a predefined period of time.

9. A method for generating follow recommendations for an online computer system, the method comprising:
presenting follow recommendations to some subset of randomly selected first set of members of an online service;
obtaining member response information indicating a response each member in the first set of members has to each follow recommendation presented to the member;
for each follow recommendation that resulted in formation of a new follow edge, obtaining engagement information indicating a level and type of engagement each member exhibited in connection with content items associated with a newly formed follow edge during some period of time subsequent to the formation of the follow edge;
using the member response information, training a first machine-learned scoring model for use in predicting when a follow recommendation presented to a member will be selected by the member, resulting in formation of a new follow edge;
using the engagement information, training a second machine-learned scoring model for use in predicting a level of engagement a member will exhibit in connection with content associated with a newly formed follow edge; and
storing both the first and second machine-learned scoring models for subsequent scoring of follow recommendations for members not in the randomly selected first set of members, wherein each follow recommendation generated for a member will be based on a combination of a first score, generated with the first machine-learned scoring model, and a second score, generated with the second machine-learned model.

10. The method of claim 9 further comprising:
for some set of members not in the subset of randomly selected first set of members, using broad heuristics, generating for each member a set of follow recommendation candidates;
for each pairing of a member and a follow recommendation candidate, extracting a first set of features and a second set of features from the respective profiles of the member and the follow recommendation candidate, and a third set of features for the pairing of the member and the follow recommendation candidate;
for each pairing of a member and a follow recommendation candidate, deriving a first score by providing the first set of features as input to the first machine-learned scoring model for predicting when a follow recommendation presented to a member will be selected by the member, resulting in formation of a new follow edge;
for each pairing of a member and a follow recommendation candidate, deriving a second score by providing the second set of features as input to the second machine-learned scoring model for predicting a level of engagement a member will exhibit in connection with content associated with a newly formed follow edge;
for each pairing of a member and a follow recommendation candidate, deriving a follow recommendation utility score, wherein the follow recommendation utility score is a combination of the first score and the second score; and
storing in a data store the follow recommendation utility score for each pairing of a member and a follow recommendation candidate.

11. The method of claim 10 further comprising:
receiving a request, associated with a particular member, for follow recommendations to be presented to the particular member;
retrieving from the data store some subset of follow recommendation candidates and corresponding follow recommendation utility scores for the particular member;
ranking the follow recommendation candidates in accordance with their respective follow recommendation utility scores; and
causing some number of the follow recommendation candidates to be presented to the particular member as follow recommendations, the follow recommendations ordered in accordance with their respective rank.

12. The method of claim 11 further comprising:
obtaining impression information identifying follow recommendations that were previously presented to the particular member in some period of time prior to when the request was received; and
discounting the follow recommendation utility score for follow recommendation candidates associated with follow recommendations that were presented to the particular member in the period of time prior to when the request was received.

13. The method of claim 11 further comprising:
subsequent to the request being received, obtaining information identifying entities the member has elected to follow and entities with whom the member has connected since the follow recommendation utility scores were last derived for the particular member; and
prior to ranking, excluding from the subset of follow recommendation candidates and follow recommendation candidate corresponding with an entity the member has elected to follow and/or with whom the member has connected since the follow recommendation utility scores were last derived for the particular member.

14. The method of claim 9, wherein the first machine-learned scoring model is based on a logistic regression model having a set of inputs and a single output, and the second machine-learned scoring model is based on log-linear regression having a set of inputs and a single output.

15. The method of claim 9, wherein the member response information includes information indicating a positive response when a member viewed a follow recommendation and then opted to follow the entity being recommended, and information indicating a negative response when a member viewed a follow recommendation and then took no action with respect to the follow recommendation

16. The method of claim 9, wherein the output of the second machine-learned scoring model, based on log-linear regression, is an estimate of the log of the expected number of interactions the member will have with a follow recommendation over a predefined period of time.

17. A system for generating follow recommendations for an online computer system, the system comprising:
a computer readable medium having instructions stored thereon, which, when executed by a processor, cause the system to:
retrieve a set of follow recommendations from a data store in response to a request associated with an end-user, each follow recommendation in the set of follow recommendations having been assigned a utility score that was previously generated by combining first and second scores, wherein the first score is the output of a first predictive machine-learned scoring model having as inputs a first set of variables, the first predictive machine-learned scoring model for use in predicting when a member will follow an entity that is presented as a follow recommendation, and the second score is the output of a second predictive machine-learned scoring model having as inputs a second set of variables, the second predictive machine-learned model for use in predicting when a member will engage with content presented in association with a newly formed follow edge, in some period of time immediately subsequent to formation of the newly formed follow edge; and
causing some subset of the retrieved follow recommendations to be presented to the end-user, the follow recommendations ranked and presented in order of their respective utility scores.

18. The system of claim 17, wherein the first predictive machine-learned scoring model has been derived using training data obtained by presenting follow recommendations to some randomly selected set of end-users, and then subsequently observing the collective responses that the randomly selected set of end users have to the follow recommendations.

19. The system of claim 17, wherein the second predictive machine-learned scoring model has been derived using training data obtained by monitoring responses that end-users have to content that is presented in connection with newly formed follow edges that resulted from presentation of a follow recommendation, the content presented during some period of time subsequent to formation of the newly formed follow edges.

20. The system of claim 17, further comprising:
additional instructions stored on a computer readable medium, which, when executed by a processor, cause the system to:
subsequent to the follow recommendations being retrieved, and prior to causing some subset of the retrieved follow recommendations to be presented to the end-user, filtering the follow recommendations to exclude follow recommendations associated with entities the end-user is following, or, with which the end-user has established a connection.
